(19) United States
(12) Patent Application Publication
(10) Pub. No.: US 2021/0298318 A1
(43) Pub. Date: Sep. 30, 2021

(54) PROCESS FOR PROCESSING MEAT PRODUCT INTO COOKED, SLICED FORM

(71) Applicant: Cuisine Solutions, Inc., Sterling, VA (US)

(72) Inventor: Jean-Pierre Guillaud, Alexandria, VA (US)

(73) Assignee: Cuisine Solutions, Inc., Sterling, VA (US)

(21) Appl. No.: 17/333,548

(22) Filed: May 28, 2021

Related U.S. Application Data
(63) Continuation-in-part of application No. 14/546,657, filed on Nov. 18, 2014, now abandoned.
Application No. 14/546,657 is a continuation of application No. 12/911,881, filed on Oct. 26, 2010, now abandoned.

(51) Int. Cl. A23B 4/005; B65B 25/06; A23L 5/10; A23B 4/06

(52) U.S. Cl. CPC A23B 4/005; A23B 4/0056; B65B 25/22; A23L 5/17; A23B 4/068; B65B 25/067

(57) ABSTRACT

A process for processing animal protein product involves providing a meat product in a raw state having a core temperature of 32-34° F., slicing the meat product into a plurality of meat slices that are 1.0-9.0 mm thick, vacuum sealing a stack of the meat slices within a pouch with the meat slices of the stack stacked together in direct meat-to-meat contact, and cooking the vacuum sealed meat slices of the stack stacked together such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing.

### CROSS-REFERENCES TO RELATED APPLICATIONS

The present application is a Continuation-In-Part of U.S. application Ser. No. 14/546,657 filed Nov. 18, 2014, which is a Continuation of U.S. application Ser. No. 12/911,881 filed Oct. 26, 2010, now abandoned, the entire content of each of which is incorporated herein by reference.

### FIELD

This invention relates to a process for processing meat product into cooked, sliced form.

### RELATED ART

Processes are known, in which a cooked meat product is shipped in the form of individual slices. The flow chart of FIG. 1 illustrates a prior art process in which a raw piece 10 of the product is cooked in an oven 12 in step S100. Then, the cooked piece of product is cut into thin, i.e., 1.0-9.0 mm thick, slices 14 in step S110. The sliced product is then heated in an oven 16, not under vacuum, to a pasteurization temperature in step S120, in an effort to destroy bacteria that may have entered the product during the slicing step. The sliced, pasteurized product is then placed in a package 18 and refrigerated for shipment in step S130.

It would be desirable to provide packages of sliced meat product in a more economical manner while also providing a better tasting, more nutritious, less shrunken, and more fully pasteurized product which resembles the entire or portion of the original muscle forming the meat.

### SUMMARY

Disclosed herein is a process for processing meat product, comprising the steps of:

A. providing a meat product in a raw state having a core temperature of 32-34° F.;
B. after step A., slicing the meat product into a plurality of meat slices that are 1.0-9.0 mm thick, in a thickness direction perpendicular to cut faces of the plurality of meat slices, while the meat product remains in the raw state having the core temperature of 32-34° F.;
C. after step B., vacuum sealing a stack of the meat slices within a pouch with the meat slices of the stack stacked together in direct meat-to-meat contact while the meat product remains in the raw state having the core temperature of 32-34° F., such that, after the vacuum sealing, the cut faces of the meat slices of the stack remain in contact with one another to essentially maintain a size and entire outer surface shape of the stack of meat slices to have a size and entire outer surface shape of an entirety of the meat forming the stack prior to the slicing; and
D. after step C., cooking the vacuum sealed meat slices of the stack stacked together with every meat slice of the stack in direct meat-to-meat contact with its adjacent meat slice or slices of the stack while still vacuum sealed in the pouch such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing.

Also disclosed herein is a process for processing meat product, comprising the steps of:

A. providing a meat product in a raw state having a core temperature of 32-34° F.;
B. after step A., searing at least one outside surface of the meat product so that the meat product, save for the at least one outside surface, remains in the raw state having the core temperature of 32-34° F.;
C. after step B., slicing the meat product into a plurality of meat slices that are 1.0-9.0 mm thick, in a thickness direction perpendicular to cut faces of the plurality of meat slices, while the meat product, save for the at least one outside surface, remains in the raw state having the core temperature of 32-34° F.;
D. after step C., vacuum sealing a stack of the meat slices within a pouch with the meat slices of the stack stacked together in direct meat-to-meat contact while the meat product is in the raw state or is in the raw state save for a seared at least one outside surface, such that, after the vacuum sealing, the cut faces of the meat slices of the stack remain in contact with one another to essentially maintain a size and entire outer surface shape of the stack of meat slices to have a size and entire outer surface shape of an entirety of the meat forming the stack prior to the slicing; and
E. after step D., cooking the vacuum sealed meat slices of the stack stacked together with every meat slice of the stack in direct meat-to-meat contact with its adjacent meat slice or slices of the stack while still vacuum sealed in the pouch such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing.

### BRIEF DESCRIPTION OF THE DRAWING FIGURES

FIG. 1 is a flow chart describing a conventional process for processing meat product.

FIG. 2 is a flow chart describing a new process for processing and packaging meat product.

### DETAILED DESCRIPTION

In the process described below, a piece of meat product is sliced while in a raw state having a core temperature of 32-34° F., and only one cooking step, i.e., which substantially raises the core temperature, is performed, in contrast to prior art processes in which the product is sliced only after being cooked, i.e., to substantially raise its core temperature, and then requires subsequent pasteurization. Moreover, a sous-vide cooking process is employed to cook the sliced product in a vacuum sealed pouch.

The flow chart of FIG. 2 depicts steps involved in the process. In a first step S200, a piece of meat product 20 that is in a raw state having a core temperature of 32-34° F. is provided. The meat product is a whole muscle or an undivided part of a whole muscle. Next, in step S210, the product is seared on one or more of its outside surfaces while remaining in the raw state having a core temperature of 32-34° F. The searing step is optional, does not raise or very minimally raises the core temperature, and will provide some texture such as grill marks.

At this point, the product has not been pasteurized, i.e., is unpasteurized and, regardless of whether it has had one or more outside surfaces seared or not, is otherwise in a raw state having a core temperature of 32-34° F. The piece of product is next cut, in a slicing machine, into slices 22, 1.0-9.0 mm thick in a thickness direction perpendicular to cut faces of the plurality of meat slices, while the meat product remains in the raw state or otherwise raw state having the core temperature of 32-34° F., in step S220.

A stack of the meat slices, which can be some or all of the meat slices and are therefore meat slices from a whole muscle or a portion of a whole muscle, is then vacuum sealed in a pouch 24 in step S230 with the meat slices of the stack stacked together in direct meat-to-meat contact while the meat product remains in the raw or otherwise raw state having the core temperature of 32-34° F., such that, after the vacuum sealing, the cut faces of the meat slices of the stack remain in contact with one another to essentially maintain a size and entire outer surface shape of the stack of meat slices to have a size and entire outer surface shape of an entirety of the meat forming the stack prior to the slicing. In other words, after vacuum sealing, the stack will appear as the whole muscle or the portion of the whole muscle, or a sub-portion of the whole muscle or of the portion of the whole muscle.

Next, the vacuum sealed stack of meat slices in the pouch are cooked in step S240, while vacuum sealed in the pouch, to at least a pasteurization temperature of the product with every meat slice of the stack in direct meat-to-meat contact with its adjacent meat slice or slices of the stack such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing. During steps S230 and S240, the slices are maintained in a tightly stacked face-to-face relationship. That is, the cut faces of the slices continue to contact one another to continue to essentially maintain the shape of the original piece of product forming the stack.

Step S240 of cooking the meat product in a vacuum sealed pouch is a sous-vide process. In this sous-vide process, cooking is preferably performed in a heated water bath 26 heated to at least the pasteurization temperature of the product, although other ways of heating the sealed product could be used.

In this sous-vide process, the product is cooked while in a sealed pouch, which allows the cellular structure of the product to remain intact. Natural moisture and juices are retained, which improves taste, retains nutritional content, and minimizes shrinkage. Additionally, the product is more fully pasteurized when the pasteurization takes place during this sous-vide process than in a prior art pasteurization process.

Heretofore, known sous-vide processes have only been performed on single pieces of meat product or on already cooked meat product, rather than on a raw sliced product or a product that is raw save for at least one seared outside surface. Surprisingly, however, a meat product initially provided as a whole muscle or portion of a whole muscle was able to be cooked by this sous-vide process without the slices coagulating together. Rather, they are easily separable. Meat product as referred to herein is consistent with The American Meat Science Association definition of meat as red meat (beef, pork, and lamb), poultry, fish/seafood, and meat from other managed species.

Following the cooking in step S240, the product can be refrigerated or frozen, while in the pouch 24, in step S250. The refrigerated or frozen product can then be shipped.

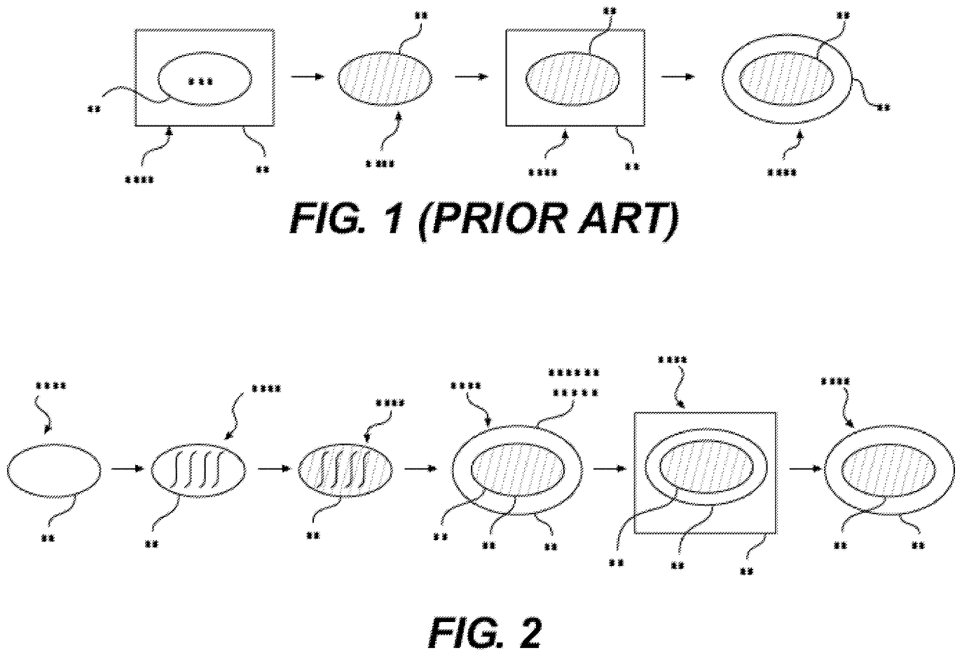

It will be appreciated that the above-described sous-vide process involves only a single cooking step for providing a pre-cooked, sliced meat product, thereby reducing cost and energy as compared to the prior art process of FIG. 1.

Although only a preferred embodiment has been described herein, it will also be appreciated that numerous changes substitutions, variations, alterations, transformations, and modifications may be suggested to one skilled in the art, which fall within the spirit and scope of the appended claims.

What is claimed is:

1. A process for processing meat product, comprising the steps of:
A. providing a meat product in a raw state having a core temperature of 32-34° F.;
B. after step A., slicing the meat product into a plurality of meat slices that are 1.0-9.0 mm thick, in a thickness direction perpendicular to cut faces of the plurality of meat slices, while the meat product remains in the raw state having the core temperature of 32-34° F.;
C. after step B., vacuum sealing a stack of the meat slices within a pouch with the meat slices of the stack stacked together in direct meat-to-meat contact while the meat product remains in the raw state having the core temperature of 32-34° F., such that, after the vacuum sealing, the cut faces of the meat slices of the stack remain in contact with one another to essentially maintain a size and entire outer surface shape of the stack of meat slices to have a size and entire outer surface shape of an entirety of the meat forming the stack prior to the slicing; and
D. after step C., cooking the vacuum sealed meat slices of the stack stacked together with every meat slice of the stack in direct meat-to-meat contact with its adjacent meat slice or slices of the stack while still vacuum sealed in the pouch such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing.

2. A process for processing meat product, comprising the steps of:
A. providing a meat product in a raw state having a core temperature of 32-34° F.;
B. after step A., searing at least one outside surface of the meat product so that the meat product, save for the at least one outside surface, remains in the raw state having the core temperature of 32-34° F.;
C. after step B., slicing the meat product into a plurality of meat slices that are 1.0-9.0 mm thick, in a thickness direction perpendicular to cut faces of the plurality of meat slices, while the meat product, save for the at least one outside surface, remains in the raw state having the core temperature of 32-34° F.;
D. after step C., vacuum sealing a stack of the meat slices within a pouch with the meat slices of the stack stacked together in direct meat-to-meat contact while the meat product is in the raw state or is in the raw state save for a seared at least one outside surface, such that, after the vacuum sealing, the cut faces of the meat slices of the stack remain in contact with one another to essentially maintain a size and entire outer surface shape of the stack of meat slices to have a size and entire outer surface shape of an entirety of the meat forming the stack prior to the slicing; and
E. after step D., cooking the vacuum sealed meat slices of the stack stacked together with every meat slice of the stack in direct meat-to-meat contact with its adjacent meat slice or slices of the stack while still vacuum sealed in the pouch such that, during the cooking, the cut faces of the meat slices of the stack remain in contact with one another to essentially maintain the size and entire outer surface shape of the stack of meat slices to have the size and entire outer surface shape of the entirety of the meat forming the stack prior to the slicing.
